(19) United States
(12) Patent Application Publication
(10) Pub. No.: US 2006/0031802 A1
(43) Pub. Date: Feb. 9, 2006

(54) Clustering-based multilevel quadratic placement

(75) Inventors: Charles Jay Alpert, Round Rock, TX (US); Gi-Joon Nam, Austin, TX (US); Paul Gerard Villarrubia, Austin, TX (US)

Correspondence Address: IBM CORPORATION (JVM), C/O LAW OFFICE OF JACK V. MUSGROVE, 2911 BRIONS WOOD LANE, CEDAR PARK, TX, 78613, US

(73) Assignee: INTERNATIONAL BUSINESS MACHINES CORPORATION, ARMONK, NY (US)

(21) Appl. No.: 10/896,495

(22) Filed: Jul. 22, 2004

(51) Int. Cl. G06F 17/50

(52) U.S. Cl. 716/10; 716/11

(57) ABSTRACT

A method of designing a layout of an integrated circuit, by grouping a plurality of logic cells in a region of the integrated circuit into at least two separate clusters, placing the clusters in the region of the integrated circuit to optimize total wire length between the clusters (e.g., using quadratic placement), partitioning the region, and recursively repeating the placing and the partitioning to place the logic cells in progressively smaller bins of the region, while ungrouping the clusters. Clustering preferably groups smaller logic cells before grouping larger logic cells, and can be repeated iteratively with further re-grouping of the clusters, prior to the placing and partitioning. The number of iterations can be limited by an operator input parameter. A given cluster is ungrouped when its size is larger than a fraction of total free space available in a corresponding bin. This fraction can also be an operator input parameter.

### BACKGROUND OF THE INVENTION

1. Field of the Invention

The present invention generally relates to the fabrication and design of semiconductor chips and integrated circuits, more specifically to a method of designing the physical layout (placement) of logic cells in an integrated circuit and the wiring (routing) of those cells, and particularly to the use of placement algorithms in designing circuit layouts.

2. Description of the Related Art

Integrated circuits are used for a wide variety of electronic applications, from simple devices such as wristwatches, to the most complex computer systems. A microelectronic integrated circuit (IC) chip can generally be thought of as a collection of logic cells with electrical interconnections between the cells, formed on a semiconductor substrate (e.g., silicon). An IC may include a very large number of cells and require complicated connections between the cells. A cell is a group of one or more circuit elements such as transistors, capacitors, resistors, inductors, and other basic circuit elements grouped to perform a logic function. Cell types include, for example, core cells, scan cells and input/output (I/O) cells. Each of the cells of an IC may have one or more pins, each of which in turn may be connected to one or more other pins of the IC by wires. The wires connecting the pins of the IC are also formed on the surface of the chip. For more complex designs, there are typically at least four distinct layers of conducting media available for routing, such as a polysilicon layer and three metal layers (metal-1, metal-2, and metal-3). The polysilicon layer, metal-1, metal-2, and metal-3 are all used for vertical and/or horizontal routing.

An IC chip is fabricated by first conceiving the logical circuit description, and then converting that logical description into a physical description, or geometric layout. This process is usually carried out using a “netlist,” which is a record of all of the nets, or interconnections, between the cell pins. A layout typically consists of a set of planar geometric shapes in several layers. The layout is then checked to ensure that it meets all of the design requirements, particularly timing requirements. The result is a set of design files known as an intermediate form that describes the layout. The design files are then converted into pattern generator files that are used to produce patterns called masks by an optical or electron beam pattern generator. During fabrication, these masks are used to pattern a silicon wafer using a sequence of photolithographic steps. The component formation requires very exacting details about geometric patterns and separation between them. The process of converting the specifications of an electrical circuit into a layout is called the physical design.

The present invention is directed to an improved method for designing the physical layout (placement) and wiring (routing) of cells. Cell placement in semiconductor fabrication involves a determination of where particular cells should optimally (or near-optimally) be located on the surface of a integrated circuit device. Due to the large number of components and the details required by the fabrication process, physical design is not practical without the aid of computers. As a result, most phases of physical design extensively use computer-aided design (CAD) tools, and many phases have already been partially or fully automated. Automation of the physical design process has increased the level of integration, reduced turn around time and enhanced chip performance. Several different programming languages have been created for electronic design automation (EDA), including Verilog, VHDL and TDML.

Placement algorithms are typically based on either a simulated annealing, top-down cut-based partitioning, or analytical paradigm (or some combination thereof). Recent years have seen the emergence of several new academic placement tools, especially in the top-down partitioning and analytical domains. The advent of multilevel partitioning as a fast and extremely effective algorithm for min-cut partitioning has helped spawn a new generation of top-down cut-based placers. A placer in this class partitions the cells into either two (bisection) or four (quadrisection) regions of the chip, then recursively partitions each region until a global coarse placement is achieved.

FIG. 1 illustrates a typical placement process according to the prior art. First, a plurality of the logic cells 2 are placed using the entire available region of the IC 4 as shown in the first layout of FIG. 1. After initial placement, the chip is partitioned, in this case, via quadrisection, to create four new regions. At the beginning of the partitioning phase some cells may overlap the partition boundaries as seen in the second layout of FIG. 1. The cell locations are then readjusted to assign each cell to a given region as shown in the final layout of FIG. 1. The process then repeats iteratively for each region, until the number of cells in a given region (bin) reaches some preassigned value, e.g., one. While FIG. 1 illustrates the placement of only seven cells, the number of cells in a typical IC can be in the hundreds of thousands, and there may be dozens of iterations of placement and partitioning. Analytical placers may allow cells to temporarily overlap in a design. Legalization is achieved by removing overlaps via either partitioning or by introducing additional forces and/or constraints to generate a new optimization problem. The classic analytical placers, PROUD and GORDIAN, both iteratively use bipartitioning techniques to remove overlaps.

Analytical placers optimally solve a relaxed placement formulation, such as minimizing total quadratic wire length. Quadratic placers thus attempt to minimize the sum of squared wire-lengths of a design according to the formula:
Φ(x)=Σ(x_{i -x}ⱼ)²
in both the horizontal and vertical directions. It can be shown that this optimization is equivalent to minimizing Φ(x) according to the formula:
Φ(x)=½x^{T}Ax−b^{T}x+c
where A is a matrix, x and b are vectors, and c is a scalar constant. Setting the derivative of this function to zero obtains the minimum value:
dΦ(x)/dx=0.
Using the equivalent function, this last equation simplifies to the linear system
Ax=b.
The solution to this linear system determines the initial locations of objects in the given placement region. This linear system can be solved using various numerical optimization techniques. Two popular techniques are known as conjugate gradient (CG) and successive over-relaxation (SOR). The PROUD placer uses the SOR technique, while the GORDIAN placer employs the CG algorithm. In general, CG is known to be more computationally efficient than SOR with a better convergence rate, but CG takes more central processing unit (CPU) time per iteration.

As device technology enters the new deep sub-micron (DSM) era, the role of placement has become more important, and more difficult. The complexity of IC designs in the DSM realm has been growing significantly mainly due to reduced device sizes. It is estimated that the number of transistors per chip will be over 1.6 billion by the year 2016. The current maximum number of objects readily handled by existing placement tools is in the range of tens of millions. While these existing placement tools could conceivably be used to find acceptable solutions with more than 10 million objects, it would likely take an unbearably long time to arrive at those solutions. Thus, current placement tools lack the scalability necessary to handle the ever-increasing number of objects in IC designs. Unfortunately, performance (i.e., quality assurance) and scalability contradict each other. Obtaining higher quality placement solutions requires more CPU time.

It would, therefore, be desirable to devise a method of improving the scalability of existing or future placement algorithms. It would be further advantageous if the new placement technique could achieve better runtime characteristics while minimizing or reducing any degradation in the quality of the solutions.

### SUMMARY OF THE INVENTION

It is therefore one object of the present invention to provide an improved method of placing logic cells on an integrated circuit (IC) chip.

It is another object of the present invention to provide such a method which enhances the scalability of the placement routines.

It is yet another object of the present invention to provide a method of designing the physical layout of an IC chip which can effectively reduce the number of objects in a design to facilitate placement in designs having very large numbers of objects.

The foregoing objects are achieved in a method of designing a layout of an integrated circuit, by grouping a plurality of logic cells in a region of the integrated circuit into at least two separate clusters, placing the clusters in the region of the integrated circuit to optimize total wire length between the clusters, partitioning the region, and recursively repeating the placing and the partitioning to place the logic cells in progressively smaller bins of the region, while ungrouping the clusters. The invention can use quadratic placement to minimize total quadratic wire length between the clusters. Clustering preferably groups smaller logic cells before grouping larger logic cells, and can be repeated iteratively with further re-grouping of the clusters, prior to the placing and partitioning. The number of iterations can be limited by an operator input parameter. A given cluster is ungrouped when its size is larger than a fraction of total free space available in a corresponding bin. This fraction can also be an operator input parameter.

The above as well as additional objectives, features, and advantages of the present invention will become apparent in the following detailed written description.

### BRIEF DESCRIPTION OF THE DRAWINGS

The present invention may be better understood, and its numerous objects, features, and advantages made apparent to those skilled in the art by referencing the accompanying drawings.

FIG. 1 is a series of plan views of an integrated circuit chip, illustrating a typical prior art placement and partitioning process for laying out the design of an integrated circuit;

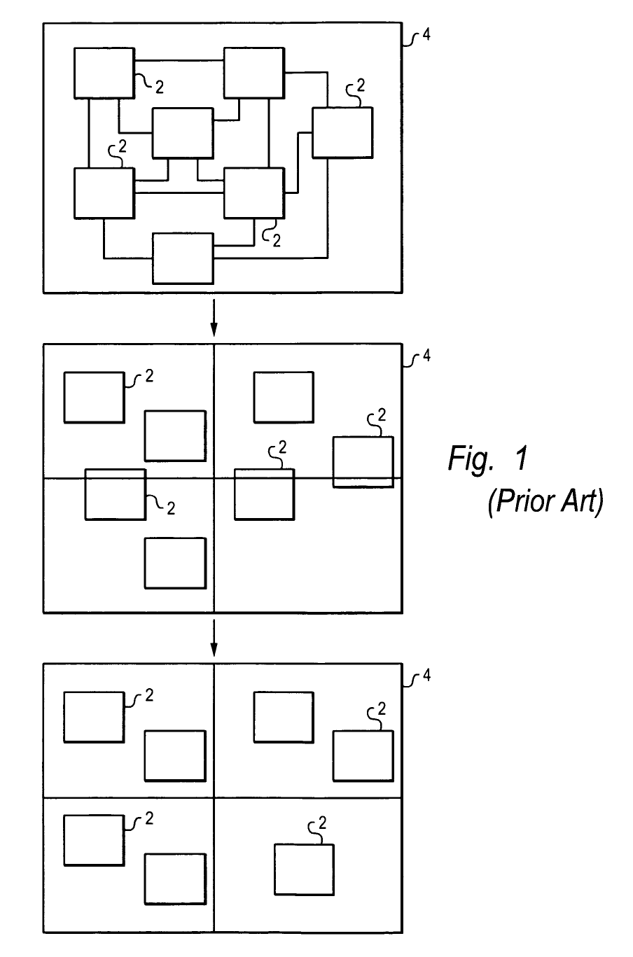

FIG. 2 is a block diagram of a computer system programmed to carry out computer-aided design of an integrated circuit in accordance with one implementation of the present invention;

FIGS. 3A and 3B are pictorial representations of two examples for grouping circuit objects into clusters while preserving all connections to external pins in accordance with the present invention, with FIG. 3A representing a “good” example of clustering, and FIG. 3B representing a “bad” example of clustering;

FIG. 4 is a diagram depicting the flow of the placement process in accordance with one implementation of the present invention, whereby objects are first grouped into clusters, then placed and partitioned recursively, with unclustering as the placement process progresses; and

FIG. 5 is a plan view of an intermediate circuit layout in accordance with the placement process depicted in FIG. 4, illustrating how a cluster can no longer fit in a bin as bin size gets progressively smaller, at which point the cluster is dissolved.

The use of the same reference symbols in different drawings indicates similar or identical items.

### DESCRIPTION OF THE PREFERRED EMBODIMENT(S)

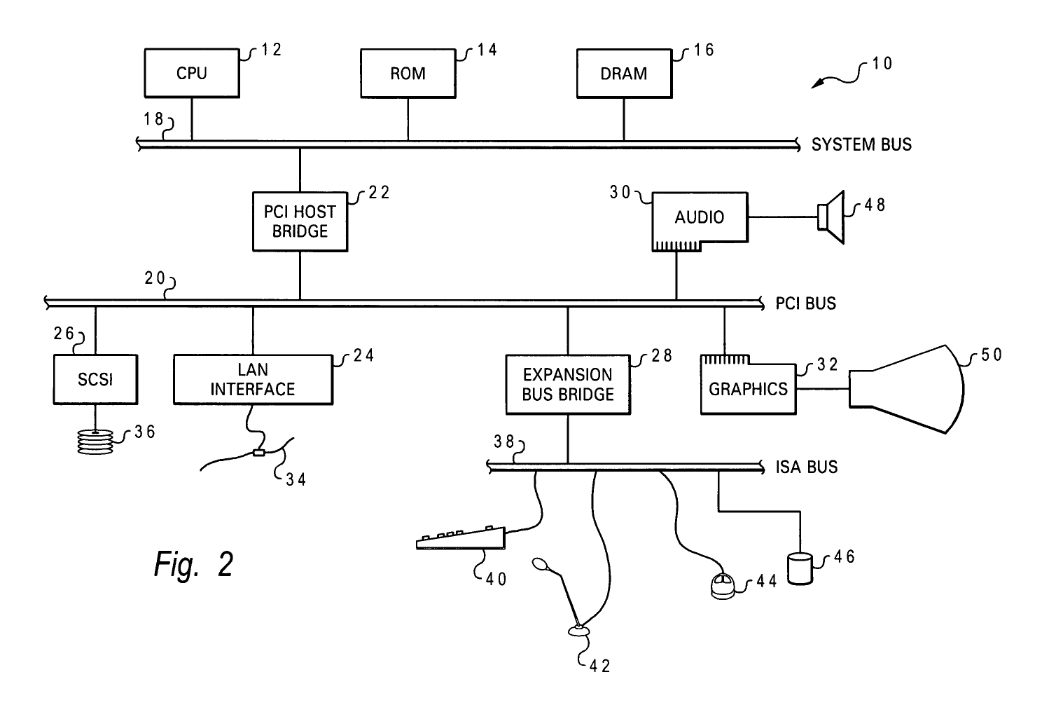

With reference now to the figures, and in particular with reference to FIG. 2, there is depicted one embodiment 10 of a computer system programmed to carry out computer-aided design of an integrated circuit in accordance with one implementation of the present invention. System 10 includes a central processing unit (CPU) 12 which carries out program instructions, firmware or read-only memory (ROM) 14 which stores the system's basic input/output logic, and a dynamic random access memory (DRAM) 16 which temporarily stores program instructions and operand data used by CPU 12. CPU 12, ROM 14 and DRAM 16 are all connected to a system bus 18. There may be additional structures in the memory hierarchy which are not depicted, such as on-board (L1) and second-level (L2) caches.

CPU 12, ROM 14 and DRAM 16 are also coupled to a peripheral component interconnect (PCI) local bus 20 using a PCI host bridge 22. PCI host bridge 22 provides a low latency path through which processor 12 may access PCI devices mapped anywhere within bus memory or I/O address spaces. PCI host bridge 22 also provides a high bandwidth path to allow the PCI devices to access DRAM 16. Attached to PCI local bus 20 are a local area network (LAN) adapter 24, a small computer system interface (SCSI) adapter 26, an expansion bus bridge 28, an audio adapter 30, and a graphics adapter 32. LAN adapter 24 may be used to connect computer system 10 to an external computer network 34, such as the Internet. A small computer system interface (SCSI) adapter 26 is used to control high-speed SCSI disk drive 36. Disk drive 36 stores the program instructions and data in a more permanent state, including the program which embodies the present invention as explained further below. Expansion bus bridge 28 is used to couple an industry standard architecture (ISA) expansion bus 38 to PCI local bus 20. As shown, several user input devices are connected to ISA bus 38, including a keyboard 40, a microphone 42, and a graphical pointing device (mouse) 44. Other devices may also be attached to ISA bus 38, such as a CD-ROM drive 46. Audio adapter 30 controls audio output to a speaker 48, and graphics adapter 32 controls visual output to a display monitor 50, to allow the user to carry out the integrated circuit design as taught herein.

While the illustrative implementation provides the program instructions embodying the present invention on disk drive 36, those skilled in the art will appreciate that the invention can be embodied in a program product utilizing other computer-readable media, including transmission media.

Computer system 10 carries out program instructions for placement of cells in the design of an integrated circuit, using a novel technique wherein objects to be placed are first grouped into clusters, then quadratically placed and partitioned recursively, with unclustering as the placement process progresses. Accordingly, a program embodying the invention may include conventional aspects of various quadratic optimizers and cut-based partitioners, and these details will become apparent to those skilled in the art upon reference to this disclosure.

In the exemplary implementation, computer system 10 carries out the quadratic placement portion of the process using the linear system Ax=b as derived in the Background section, but initially applies this process to collections of cells, rather than individual cells. By solving this equation as applied to these cell clusters, the optimal (or near-optimal) locations of the clusters can be determined to minimize the sum of squared wirelength. When an illegal placement solution arises (with substantial cell/cluster overlappings) a partitioning step uses the overlapping layout to assign cells to either 2 or 4 sub-regions (bins). The solution to the same linear system is used for the subsequent partitioning. Instead of minimizing the number of cuts, a geometric partitioning algorithm can be used to minimize the total sum of movements from the initial quadratic placement solutions. The placement process repeats recursively on each bin until eventually all the cells are in their own bins, and the placement is legal. Unclustering occurs as the process progresses as explained further below. The global placement is followed by a detailed placement which set the exact coordinates of each object subject to row and slot constraints.

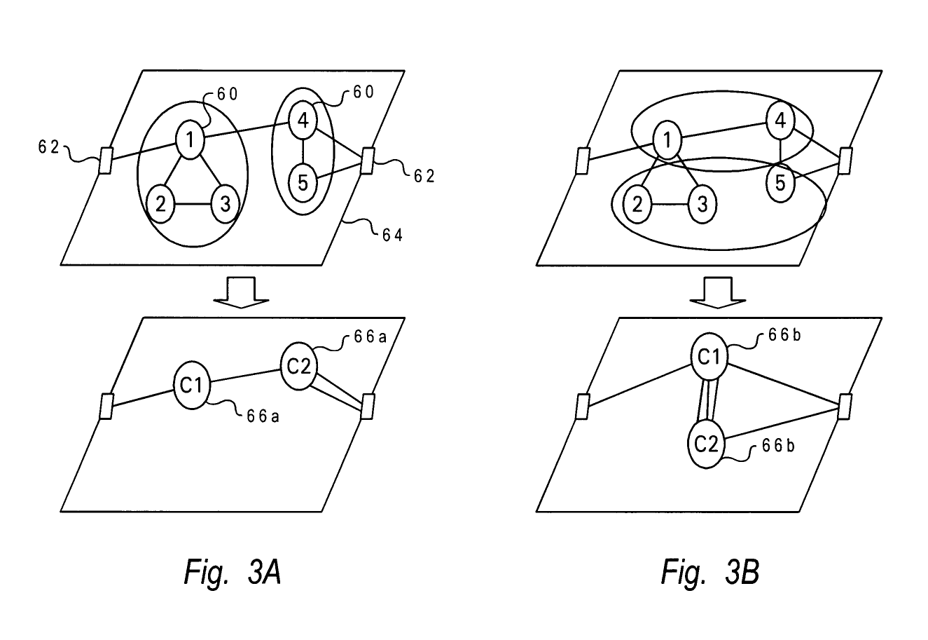

An initial problem arises as to how to group the cells into clusters. Clustering can be an efficient method to reduce the number of objects in a design, depending on the clustering strategy. The idea is to generate a single object from a set of tightly connected objects while preserving all the connections to the outside. FIGS. 3A and 3B illustrate a clustering technique on a simple placement problem. In the initial layout of FIG. 3A, there are five cells 60 (moveable objects) numbered from 1 to 5, and two fixed I/O pins 62 on either side of the IC chip 64. By performing a simple 1-level clustering, a new placement problem instance can be generated with only 2 moveable objects 66a, C1 (a cluster from objects 1, 2, 3) and C2 (a cluster from objects 4, 5). For cluster C1, external connections (one for fixed I/O and another for object 4) are preserved while internal nets (between object 1 and 2, 1 and 3, 2 and 3) are absorbed into C1.

Different clustering strategies produce different placement problem instances. In FIG. 3B, the initial layout is the same as with FIG. 3A, but a different grouping of the cells results in a different net for the clusters. In this alternate grouping, two clusters 66b are generated from objects 1, 4 and from objects 2, 3, 5. Though the second placement problem in FIG. 3B has the same number of moveable objects as FIG. 3A, it has a more complex net structure which is harder for a quadratic placer to optimize, and is unsatisfactory in comparison.

Small objects are preferably clustered first. A cluster “score” can be defined by dividing the number of pin connections by the bin size, or by including other parameters such as the size of the objects, connection force (i.e., net weight), and geometric location. Clustering can be performed iteratively, i.e., at multiple levels. In general, more clustering tends to generate more complex objects and net structures, but fewer numbers of moveable objects. The program operator can provide a control parameter to limit the amount of clustering, such as a factor by which the object count is to be reduced. Better clustering produces better quality of solutions, such as wire length and timing (shorter delay).

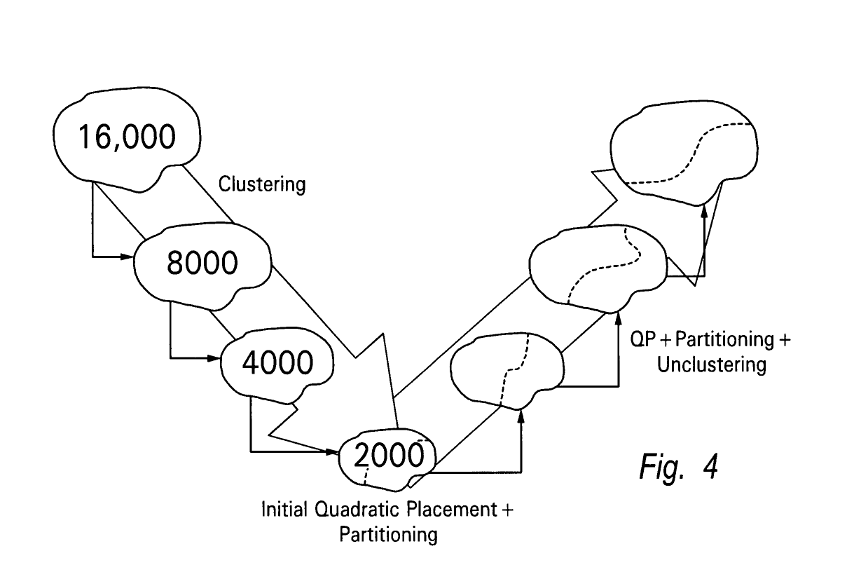

FIG. 4 shows the flow of the enhanced placement algorithm with clustering/unclustering techniques in accordance with an exemplary implementation. First, the cells are gradually clustered into a coarsened netlist. In this example, the layout begins with 16,000 cells (moveable objects). Clustering is iteratively performed, reducing the number of objects to 8,000, 4,000, then 2,000. At this point (based on operator input), the 2,000 objects undergo an initial quadratic placement followed by partitioning. This initial quadratic placement and partitioning is followed recursively with more quadratic placement (QP) and partitioning, and unclustering of the objects.

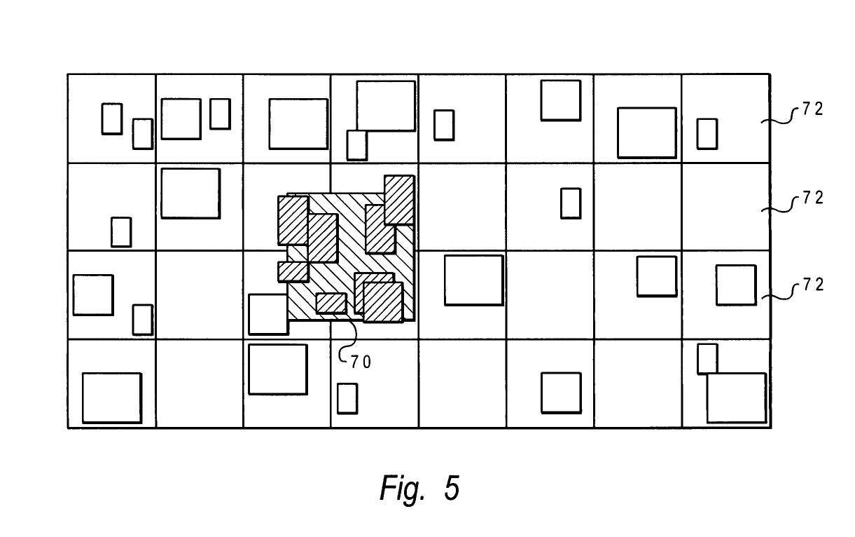

Referring now to FIG. 5, different strategies can also be used to ungroup the clusters as partitioning progresses. In a recursive partitioning placement, the size of the bins diminishes as placement progresses. It is thus possible to have a cluster object 70 which is bigger than the size of a bin 72 to which it is assigned, but this situation is undesirable because there should remain enough free space to produce a legal solution in any placement region. Therefore, an automatic unclustering technique can be employed in recursive partitioning placement for better quality of solutions wherein the size of a cluster is compared with the available free space in a bin. If the size of the cluster is larger than some fraction (i.e., 5%) of total free space available in a bin, the cluster can be dissolved into a set of smaller children objects (i.e., cells or sub-clusters). This strategy assures that every object within a bin is smaller than the actual bin size.

The implementation of FIG. 4 may also be expressed in pseudo-code as follows:

B = Ø
generate clusters from initial objects
add entire_chip_area to B
while (any bin ∈ B has more objects than maxT)

for each bin ∈ B with more objects than maxT

extract bin from B
construct linear equation A · x = b
solve equation
do bisection or quadrisection
uncluster objects based on its size
add sub_bins to B

end for

end while
uncluster any clustered objects
do global_placement clean up
do detailed_placement

In this pseudo-code, “objects” refers to individual cells as well as cell clusters or sub-clusters. The algorithm starts by performing clustering on initial moveable objects. The degree of clustering is controlled by the operator input parameter. Whenever partitioning is performed during the placement, selective unclustering is executed based on the size of cluster objects. Once every bin size is fine-grained with a trivial number of objects (maxT) and if there still are clustered objects, those clusters are unconditionally unclustered. At this end point, there are the same set of objects as in the initial placement problem. Simulations using the present invention indicate that it can achieve a significant speed-up in the layout process as compared to prior art techniques, with only marginal total wirelength degradation.

Although the invention has been described with reference to specific embodiments, this description is not meant to be construed in a limiting sense. Various modifications of the disclosed embodiments, as well as alternative embodiments of the invention, will become apparent to persons skilled in the art upon reference to the description of the invention. It is therefore contemplated that such modifications can be made without departing from the spirit or scope of the present invention as defined in the appended claims.

What is claimed is:

1. A method of designing a layout of an integrated circuit, comprising:
grouping a plurality of logic cells in a region of the integrated circuit into at least two separate clusters;
placing the clusters in the region of the integrated circuit to optimize total wire length between the clusters;
partitioning the region; and
recursively repeating said placing and said partitioning to place the logic cells in progressively smaller bins of the region, while ungrouping the clusters.

2. The method of claim 1 wherein said placing uses quadratic placement to minimize total quadratic wire length between the clusters.

3. The method of claim 1 wherein said grouping groups smaller logic cells before grouping larger logic cells.

4. The method of claim 1 wherein said grouping is repeated iteratively with further re-grouping of the clusters, prior to said placing and partitioning.

5. The method of claim 4 wherein iterations of said re-grouping are limited by an operator input parameter.

6. The method of claim 1 wherein a given cluster is ungrouped when its size is larger than a fraction of total free space available in a corresponding bin.

7. The method of claim 6 wherein the fraction is an operator input parameter.

8. A computer system comprising:
means for processing program instructions;
a memory device connected to said processing means; and
program instructions residing in said memory device for designing a layout of an integrated circuit by grouping a plurality of logic cells in a region of the integrated circuit into at least two separate clusters, placing the clusters in the region of the integrated circuit to optimize total wire length between the clusters, partitioning the region, and recursively repeating the placing and the partitioning to place the logic cells in progressively smaller bins of the region, while ungrouping the clusters.

9. The computer system of claim 8 wherein said program instructions use quadratic placement to minimize total quadratic wire length between the clusters.

10. The computer system of claim 8 wherein said program instructions group smaller logic cells before grouping larger logic cells.

11. The computer system of claim 8 wherein said program instructions iteratively repeat the grouping, with further re-grouping of the clusters prior to the placing and partitioning.

12. The computer system of claim 11 wherein iterations of said re-grouping are limited by an operator input parameter.

13. The computer system of claim 8 wherein said program instructions ungroup a given cluster when its size is larger than a fraction of total free space available in a corresponding bin.

14. The computer system of claim 13 wherein the fraction is an operator input parameter.

15. A computer program product comprising:
a computer-readable medium; and
program instructions residing in said medium for designing a layout of an integrated circuit, wherein said program instructions group a plurality of logic cells in a region of the integrated circuit into at least two separate clusters, place the clusters in the region of the integrated circuit to optimize total wire length between the clusters, partition the region, and recursively repeat the placing and the partitioning to place the logic cells in progressively smaller bins of the region, while ungrouping the clusters.

16. The computer program product of claim 15 wherein said program instructions use quadratic placement to minimize total quadratic wire length between the clusters.

17. The computer program product of claim 15 wherein said program instructions group smaller logic cells before grouping larger logic cells.

18. The computer program product of claim 15 wherein said program instructions iteratively repeat the grouping, with further re-grouping of the clusters prior to the placing and partitioning.

19. The computer program product of claim 18 wherein iterations of said re-grouping are limited by an operator input parameter.

20. The computer program product of claim 15 wherein said program instructions ungroup a given cluster when its size is larger than a fraction of total free space available in a corresponding bin.

21. The computer program product of claim 20 wherein the fraction is an operator input parameter.
